(19) United States
(12) Patent Application Publication
(10) Pub. No.: US 2011/0184839 A1
(43) Pub. Date: Jul. 28, 2011

(54) SYSTEM AND METHOD FOR MANAGING AVATAR ON INSTANT MESSAGING PLATFORM

(75) Inventors: Jian CHEN, Shenzhen (CN); Lei Song, Shenzhen (CN)

(73) Assignee: TENCENT TECHNOLOGY (SHENZHEN) COMPANY LIMITED, Shenzhen (CN)

(21) Appl. No.: 13/075,893

(22) Filed: Mar. 30, 2011

Related U.S. Application Data
(63) Continuation of application No. PCT/CN2009/074037, filed on Sep. 18, 2009.

(30) Foreign Application Priority Data
Oct. 7, 2008 (CN) 200810148869.5

(51) Int. Cl. G06F 3/01; G06Q 30/00

(52) U.S. Cl. 705/27.1; 715/753

(57) ABSTRACT

The present invention relates to instant messaging (IM) technologies, and provides a system and method for managing an avatar on an instant messaging (IM) platform. The method is based on at least one terminal and includes steps of: A) detecting an area where an action takes place and determining a virtual element of a first avatar which is an object of the action according to the area; and B) performing an operation corresponding to the action on the virtual element, updating a second avatar by combining the second avatar with the virtual element. According to the method and system in the present invention, service experience of users can be improved.

### FIELD OF THE INVENTION

The present invention relates to instant messaging (IM) technologies, and particularly, to a system and method for managing an avatar on an IM platform.

### BACKGROUND OF THE INVENTION

Currently, personal avatars have been widely applied to IM platforms. An avatar can provide variable as-you-please dresses, facial expressions, motions, and various scenarios as well. The avatar service is attracting more and more users due to its strong expressive ability. For example, in QQ show and some game scenarios, a user can dress up his/her avatar according to his/her preference and also to make his image vivid on the Internet.

Most of current avatars on the Internet include multiple parts, e.g. head, shoes, accessories and scenarios, etc. A user can change his/her avatar via the Internet by changing different parts of the avatar. Furthermore, the Internet provides e-stores, in which a user can purchase all kinds of virtual goods, such as hats, hair, clothes and so on to dress up his/her avatar of his/her style.

According to the prior art, the avatar is generally displayed by a terminal of the IM platform. When the user wants to update his/her avatar, the user needs to directly log onto an e-store website via a webpage. The e-store website may provide a list of various virtual elements which form an avatar. Then the user may select his/her favorite virtual elements (such as hair, clothes, accessories and scenarios), click on selected items to try them on and preview the avatar, and then purchase the items in the e-store. After purchasing the selected items, the purchased items will be automatically stored in a virtual shopping basket. The user may browse the virtual shopping basket, click on the purchased virtual goods to dress up his/her avatar, and finally save his/her avatar. Thus, each time the user logs onto the IM platform, the virtual items purchased and the avatar updated will be displayed.

The e-store may update virtual goods at any time to provide more virtual goods. However, most users are not used to logging on the e-store periodically to find new virtual goods. More often, a user wants to visit the e-store only when it jumps into his/her mind or when he/she sees certain virtual goods in an avatar of his/her IM contact via an IM tool and wants to try the virtual goods. The user then has to log onto the e-store directly via a webpage, search for the virtual goods in the e-store, and try on the virtual goods. As can be seen, it is inconvenient and time-consuming to update an avatar.

Therefore, there is the need for an improved system and method for managing an avatar on an IM platform, which makes it less time-consuming to update an avatar.

### SUMMARY OF THE INVENTION

In view of the above, embodiments of the present invention provide a system and method for managing an avatar on an IM platform, which makes updating an avatar less time-consuming.

The system includes at least one terminal for displaying an avatar. The terminal includes:

a management module, configured to detect an area where an action takes place, determine a virtual element of a first avatar which is an object of the action according to the area, perform an operation corresponding to the action on the virtual element, update a second avatar by combining the second avatar with the virtual element.

The method is based on at least one terminal, including:

A) detecting an area where an action takes place and determining a virtual element of a first avatar which is an object of the action according to the area;

B) performing an operation corresponding to the action on the virtual element, updating a second avatar by combining the second avatar with the virtual element.

As can be seen from the above, during the process of managming an avatar in the present invention, the terminal can provide try-it-on function and preview function by dividing and re-combining an avatar. A user can preview his/her favorite virtual goods without logging into the e-store. Thereby, the time needed for updating an avatar is shortened. In addition, during managing the avatar, the terminal can provide purchase function without requiring the user to log into the e-store via a webpage, which makes it more convenient to purchase an avatar and better satisfies requirements of users. Besides, after being purchased, the avatar can be directly saved via the terminal, and the terminal can jump to the position of a virtual element in the e-store by a click of the user on the virtual element. Therefore, the user can quickly locate the virtual element in the e-store, and can also browse other commodities arranged adjacent to the virtual element, which further improves service experience of the user.

### BRIEF DESCRIPTION OF THE DRAWINGS

FIG. 1 is a schematic illustrating a structure of a system for managing an avatar on an IM platform in accordance with an embodiment of the present invention.

FIG. 2 is a schematic illustrating an internal structure of a management module in accordance with an embodiment of the present invention.

FIG. 3 is a schematic illustrating a structure of a system for purchasing an avatar in accordance with an embodiment of the present invention.

FIG. 4 is a schematic illustrating a structure of a system for purchasing an avatar in accordance with an embodiment of the present invention.

FIG. 5 is a schematic illustrating an internal structure of a purchasing module in accordance with an embodiment of the present invention.

FIG. 6 is a schematic illustrating an internal structure of a terminal in accordance with an embodiment of the present invention.

FIG. 7 is a flowchart illustrating a method for managing an avatar on an IM platform in accordance with an embodiment of the present invention.

FIG. 8 is a flowchart illustrating a method for managing an avatar on an instant messaging platform in accordance with an embodiment of the present invention.

FIG. 9 is a flowchart illustrating a method for purchasing an avatar in accordance with an embodiment of the present invention.

FIG. 10 is a flowchart illustrating a method for purchasing an avatar in accordance with an embodiment of the present invention.

FIG. 11 is a flowchart illustrating a method of jumping from a virtual element to an e-store in accordance with an embodiment of the present invention.

### DETAILED DESCRIPTION OF THE INVENTION

According to an embodiment, a terminal detects an area where an action takes place, determines a virtual element which is an object of the action according to the area, performs an operation on the virtual element according to the action, updates and displays an avatar. Through the above process, the time needed for updating an avatar can be shortened.

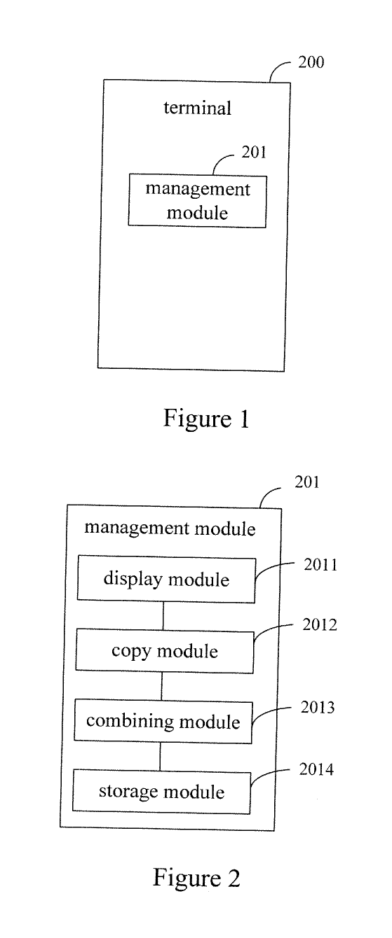

FIG. 1 is a schematic illustrating a structure of a system for managing an avatar on an IM platform in accordance with an embodiment of the present invention. As shown in FIG. 1, the system includes a terminal 200. It should be noted that the system in FIG. 1 is merely a simplified system of the present invention and should include at least one terminal 200.

The terminal 200 is configured to display an avatar and includes a management module 201.

The management module 201 is configured to detect an area where an action takes place, determine a virtual element which is an object of the action according to the area, perform an operation corresponding to the action on the virtual element, update and display the avatar.

It should be noted that the terminal 200 may typically be a client in which dedicated client software (e.g. an instant messenger, an online game, etc.) is installed and running, or may be a web browser which provides a webpage forum or a web chatting tool. When the terminal 200 is a web browser, the above functions are implemented with the assistance of a web server.

The above mentioned action may be initiated by a user via various kinds of input devices (such as a mouse, a keyboard, a touch screen, etc.), or may be an action initiated in other man-machine interaction modes.

FIG. 2 is a schematic illustrating an internal structure of a management module 201 in accordance with an embodiment of the present invention. The management module 201 includes a display module 2011, a copy module 2012, a combining module 2013 and a storage module 2014.

The display module 2011 is configured to display virtual elements constituting an avatar.

The copy module 2012, connected with the display module 2011, is configured to copy a virtual element which is clicked on to obtain a virtual element copy.

The combining module 2013, respectively connected with the display module 2011 and the copy module 2012, is configured to detect an area which is clicked on or an area where a mouse key is released, determine a virtual element which is an object of the click or the release according to the area, and replace a virtual element which is located in the area with the virtual element copy.

According to an embodiment, when a user clicks on a certain virtual element of a contact's avatar, such as a hat, the combining module 2013 detects an area where a click of a mouse key takes place and determines a virtual element which is operated by the user, and the copy module 2012 copies the virtual element determined to obtain a hat copy. Then the user drags the hat copy onto his/her avatar and releases the mouse key. The combining module 2013 detects the area where the mouse key is released, and determines a virtual element which is to be replaced in an original avatar. Then the combining module 2013 replaces the determined virtual element of the original avatar with the hat copy.

In a preferred embodiment of the present invention, the display module 2011 may implement the replacement by hiding a hat in the original avatar and displaying the hat copy.

The storage module 2014, respectively connected with the display module 2011, the copy module 2012 and the combining module 2013, is configured to store virtual elements constituting an avatar. According to an embodiment, the storage module 2014 is configured to store the virtual elements, including hair, clothes, hats, pants, shoes, accessories and scenarios, etc. In other words, an avatar can be divided into several virtual elements and the virtual elements can be “worn” by an original avatar, so that the avatar of the user can be varied and colorful.

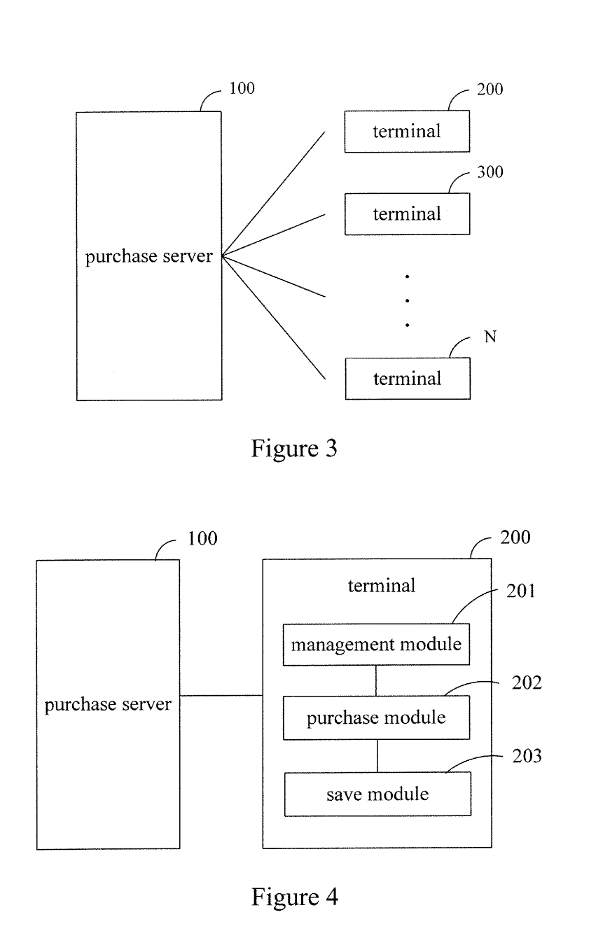

FIG. 3 is a schematic illustrating a structure of a system for purchasing an avatar in accordance with an embodiment of the present invention. The system includes a purchase server 100, and a plurality of terminals (terminals 200, 300, 400, . . . , N) which are respectively connected with the purchase server 100 and capable of interacting data with the purchase server 100.

It should be noted that connections between devices shown in the figures of the present invention are for explaining the process of information interaction and controlling more clearly, thus can be regarded as logical connections and should not be limited to physical connections. In addition, all modules may communicate with each other in any means of communication, and should not be limited to one specific type of communication manner.

The purchase server 100 is configured to run an e-store, and may be any purchase server which provides a purchase service, such as a purchase server of a large-scale e-store website capable of providing purchase service.

Each of the terminals (terminals 200, 300, 400, . . . , N), connected with the purchase server 100 and capable of performing data interaction with the purchase server 100, is configured to display an avatar. Each of the terminals may typically be a client in which dedicated client software (e.g. an instant messenger or online game) is installed and running, or may be a web browser providing a webpage forum or a cyber-chatting tool. When each of the terminals is a web browser, the data interaction with the purchase server 100 is implemented via a web server.

FIG. 4 is a schematic illustrating a structure of a system for purchasing an avatar in accordance with an embodiment of the present invention. The system is a simplified system for purchasing an avatar, and includes a purchase server 100 and a terminal 200.

The purchase server 100 is configured to run an e-store, make a purchase according to a received serial number of a virtual element and received security information of a user, and return a result of the purchase.

The terminal 200, connected with the purchase server 100 and capable of interacting data with the purchase server 100, includes a management module 201, a purchase module 202 and a save module 203.

The management module 201 is configured to detect an area of an action, determine a virtual element which is the object of the action according to the area, perform an operation on the virtual element according to the action, update and display an avatar.

The purchase module 202, connected with the management module 201, is configured to obtain the serial number of the virtual element to be purchased and the security information of the user, and send the serial number and the security information to the purchase server 100.

The save module 203, respectively connected with the management module 201 and the purchase module 202, is configured to send a saving protocol to the purchase server 100 requesting to save the avatar. The purchase server 100 saves the avatar which is requested to be saved by the save module 203.

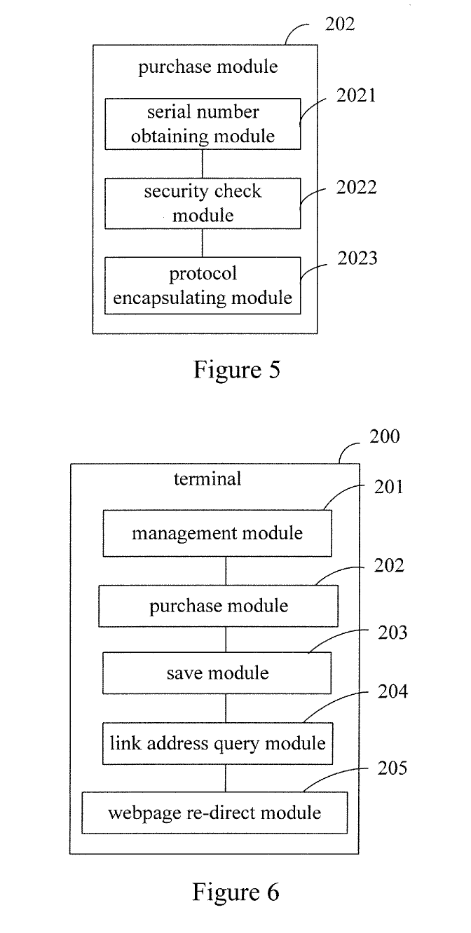

FIG. 5 is a schematic illustrating an internal structure of a purchase module 202 in accordance with an embodiment of the present invention. The purchase module 202 includes a serial serial number obtaining module 2021, a security check module 2022 and a protocol encapsulating module 2023.

The serial number obtaining module 2021 is configured to obtain a serial number of a virtual element to be purchased. According to an embodiment, when the user needs to purchase a virtual element such as clothes, the user clicks on it to purchase it and the serial number obtaining module 2021 obtains the serial number of the virtual element in the e-store. After receiving the serial number, the purchase server 100 then knows which virtual element the user is to purchase.

The security check module 2022, connected with the serial number obtaining module 2023, is configured to obtain the security information of the user according to a security check policy selected by the purchase server 100. According to an embodiment, after receiving a purchase request, the purchase server 100 may determine which security check policy should be adopted according to network conditions between the purchase server 100 and the terminal 200.

According to an embodiment, the purchase server 100 does not require the user to log into the e-store. Instead, the security check module 2022 directly obtains a login check code of the user to form the security information of the user. According to another embodiment, the purchase server 100 requires the user to log into the e-store. Then, after the terminal 200 pops up a login box and the user inputs login information, the security check module 2022 obtains the security information of the user to implement e-store logon.

The protocol encapsulation module 2023, connected with the serial number obtaining module 2021 and the security check module 2022 respectively, is configured to perform protocol encapsulation on the serial number of the virtual element to be purchased and the security information of the user, and transmit a protocol packet obtained by the protocol encapsulation to the purchase server 100.

FIG. 6 is a schematic illustrating an internal structure of a terminal 200 in accordance with an embodiment of the present invention. Besides the management module 201, the purchase module 202 and the save module 203, the terminal 200 further includes a link address query module 204 and a webpage jump module 205.

The link address query module 204 is configured to obtain the serial number of the virtual element, query the e-store for a link address of the virtual element according to the serial number of the virtual element.

The webpage jump module 205, connected with the link address query module 204, is configured to obtain the security information of the user and jump to the position of the virtual element in the e-store according to the link address.

In this embodiment, because virtual elements are arranged on a virtual shelf in the e-store, commodities belonging to the same category are usually arranged to be adjacent to each other. For example, the virtual elements are classified into different categories including clothes, pants and hair, or the newest commodities are classified into one category. When the user clicks on or drags a certain virtual element, the webpage jump module 205 automatically starts a browser which jumps to the position of the virtual element in the e-store, and enables the user to enter the e-store in a having-logged-on state. Thus, the user can browse commodities adjacent to the virtual element in the e-store.

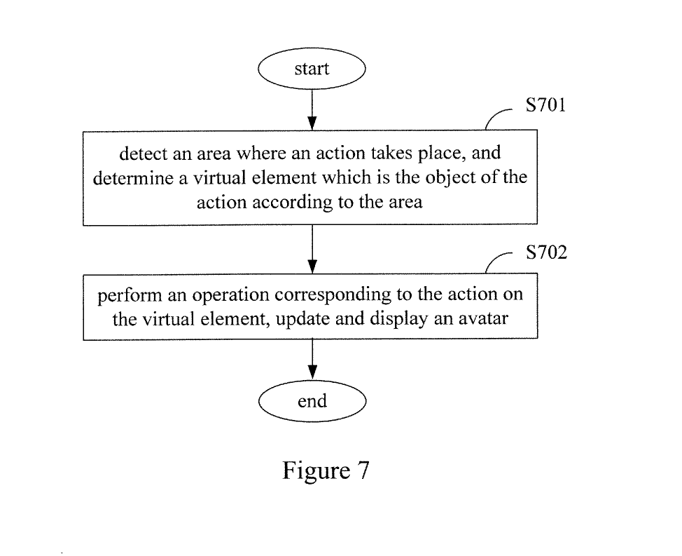

FIG. 7 is a flowchart illustrating a method for managing an avatar on an IM platform in accordance with an embodiment of the present invention. The method is carried out in the system structure shown in FIG. 1 and is as follows.

In step S701, the management module 201 detects an area where an action takes place, and determines a virtual element which is the object of the action according to the area.

In step S702, the management module 201 performs an operation on the virtual element according to the action, updates and displays an avatar.

The above action may be initiated by a user via various input devices (such as a mouse, a keyboard, a touch screen, etc.), or via other man-machine interaction means.

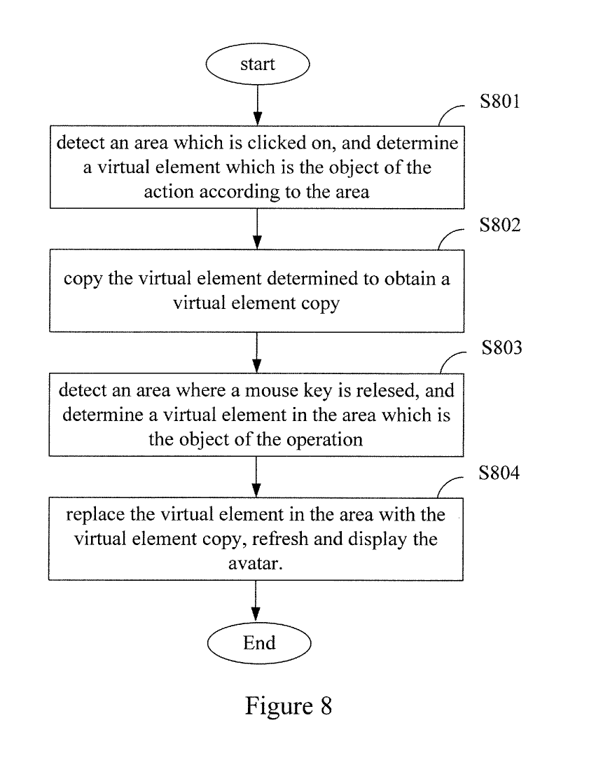

FIG. 8 is a flowchart illustrating a method for managing an avatar on an IM platform in accordance with an embodiment of the present invention. The method is carried out based on the system structure shown in FIG. 2 and is as follows.

In step S801, the combining module 2013 detects an area where an action takes place, and determines a virtual element which is the object of the action according to the area. According to an embodiment, when a user clicks on a certain virtual element of a contact's avatar, the combining module 2013 detects an area where a click takes place and determines the virtual element to be operated by the user according to the area.

In step S802, the copy module 2012 copies the determined virtual element to obtain a virtual element copy. According to an embodiment, when a user clicks on a certain virtual element using a mouse and then drags the virtual element onto his/her avatar, the copy module 2012 copies the virtual element clicked on to obtain the virtual element copy.

In step S803, the combining module 2013 detects an area where a mouse key is released, and determines a virtual element in the area which is the object of the action. According to an embodiment, the user drags the virtual element copy onto his/her avatar using the mouse and releases the mouse key; the combining module 2013 detects the area where the mouse key is released to determine a virtual element to be replaced in an original avatar.

In step S804, the combining module 2013 replaces the virtual element in the area with the virtual element copy, refreshes and displays the avatar. According to an embodiment, detailed process of step S804 may be as follows: the display module 2011 hides the original virtual element in the area where the mouse key is released and displays the virtual element copy obtained. Meanwhile, the combining module 2013 may perform logic adjustment to the virtual element copy to adapt the virtual element copy to the avatar. Then, the display module 2011 refreshes and displays the avatar.

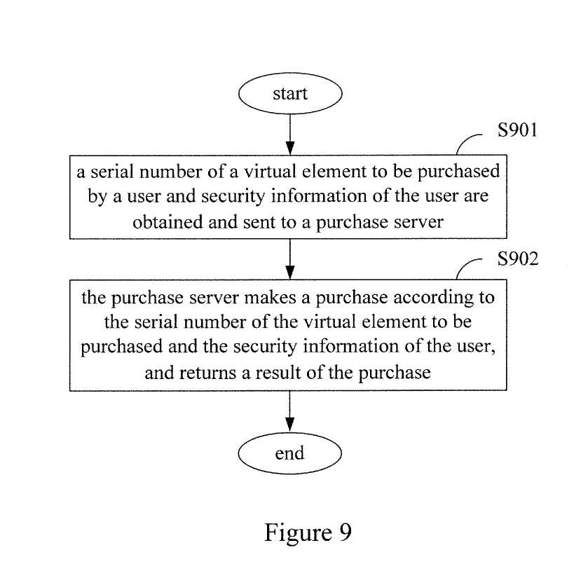

FIG. 9 is a flowchart illustrating a method for purchasing an avatar in accordance with an embodiment of the present invention. The method is based on the system structure shown in FIG. 4 and includes steps as follows.

In step S901, a serial number of a virtual element to be purchased by a user and security information of the user are obtained and sent to a purchase server 100.

In step S902, the purchase server 100 makes a purchase according to the serial number of the virtual element and the security information of the user, and returns a result of the purchase.

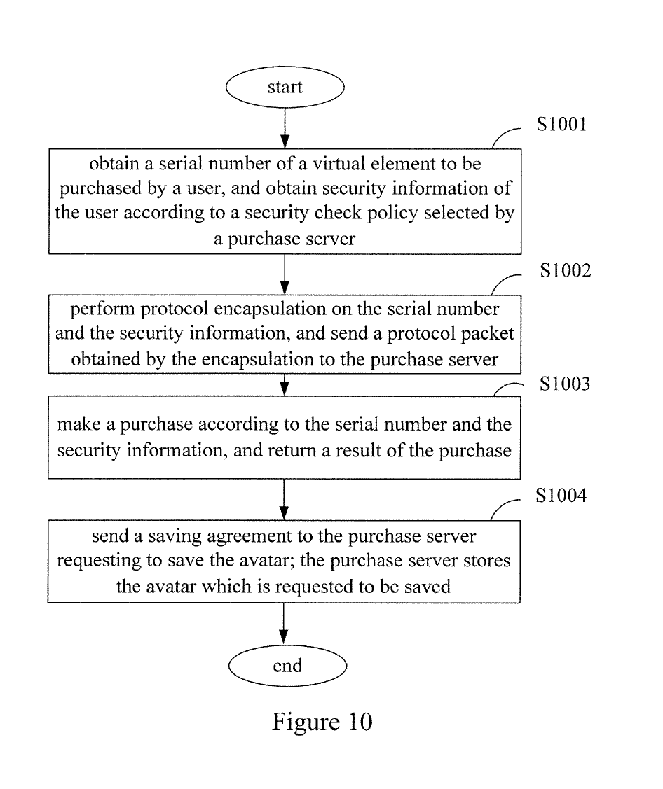

FIG. 10 is a flowchart illustrating a method for purchasing an avatar in accordance with an embodiment of the present invention. The method is based on the system structure shown in FIG. 4 and includes steps as follows.

In step S1001, a terminal 200 obtains a serial number of a virtual element to be purchased by a user, and obtains security information of the user according to a security check policy selected by a purchase server 100.

According to an embodiment, detailed process of the step S1001 may include: after the user drags a certain virtual element from a contact's avatar onto his/her avatar and previews the avatar with the dragged virtual element, if the user clicks on the virtual element to purchase it, the serial number obtaining module 2021 obtains the serial number of the virtual element to be purchased and meanwhile queries the purchase server 100 for a security check policy to be used. The purchase server 100 may select different security policies according network conditions between the purchase server 100 and the terminal 200.

According to an embodiment, the purchase server 100 does not require the user to log into the e-store. Instead, the security check module 2022 directly obtains a login check code of the user. According to another embodiment, the purchase server 100 requires the user to log into the e-store. In this case, after the terminal 200 pops up a login box and the user inputs login information, the security check module 2022 obtains the security information of the user for e-store login.

In step S1002, the protocol encapsulation module 2023 performs protocol encapsulation on the serial number of the virtual element to be purchased and the security information of the user, and transmits a protocol packet obtained by the protocol encapsulation to the purchase server 100.

In step S1003, the purchase server 100 makes the purchase according to the serial number of the virtual element to be purchased and the security information of the user, and returns a result of the purchase.

According to an embodiment, the step S1003 specifically includes: the purchase server 100 receives the protocol packet, obtains the serial number of the virtual element to be purchased and the security information of the user, and finishes the purchase process in the e-store. During the purchase process, the cost of the virtual element may be automatically deducted from his/her virtual coins according to the price of the virtual element, and the purchased virtual element is automatically placed in a shopping basket of the user in the e-store. After the purchase is made, the purchase server 100 returns purchase success information to the terminal 200, for example by prompting an information box to indicate the user that the purchase is successful. If the user's account balance is insufficient or the purchase is failed due to network failure, the purchase server 100 returns information about balance insufficiency or about purchase failure to the terminal 200, for example by prompting an information box indicating the user that the user's account balance is insufficient or that the operation is failed, etc.

In step S1004, the save module 203 sends a saving protocol to the purchase server 100 requesting saving the avatar; the purchase server 100 stores the avatar which is requested to be saved by the save module 203.

According to an embodiment, the step S1004 may specifically includes: after the user successfully purchased the virtual element, the save module 203 transmits the saving protocol to the purchase server 100 requesting to save the avatar, and the purchase server 100 stores the avatar which is requested to be saved by the save module 203. Each time the user logs onto the IM platform, the purchase server 100 transmits the stored latest avatar to the terminal 200 for being displayed.

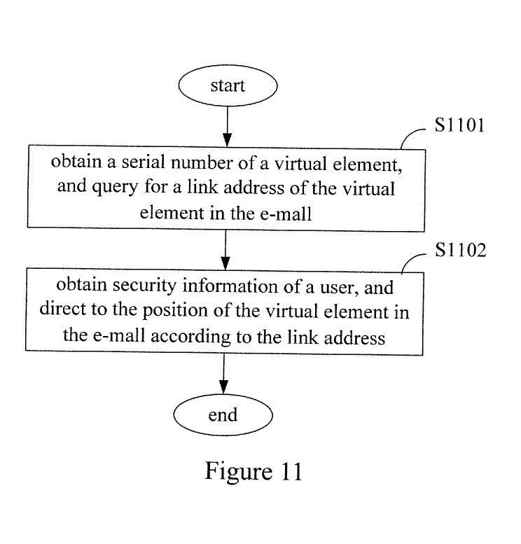

FIG. 11 is a flowchart illustrating a method of a virtual element jumping to an e-store in accordance with an embodiment of the present invention. The method is based on the structure shown in FIG. 5 and is described as follows.

In step S1101, a link address query module 204 obtains a serial number of a virtual element, and queries the e-store for a link address of the virtual element.

According to an embodiment, the purchase server 100 stores the serial number of the virtual element in the e-store. In addition, each virtual element has a link address in the e-store, and the link address is associated with the position of the virtual element in the e-store.

In step S1102, the webpage jump module 205 obtains security information of the user, and jumps to the position of the virtual element in the e-store according to the link address.

According to an embodiment, the webpage jump module 205 obtains the security information of the user to enable the user to enter the e-store in a having-logged-on state, and jumps to the position of the virtual element in the e-store according to the link address obtained by the link address query module 204. Because commodities belonging to the same category are usually arranged to be adjacent to each other in the e-store, the user can browse other commodities adjacent to the virtual element when the user is directed to the shelf where the virtual element is located according to the link address; or the user may be directed to the e-store via the virtual element and directly make the purchase in the e-store.

It should be noted that the present invention can be applied to, but not limited to, the instant messenger, and can also be applied to other similar tools capable of displaying an avatar, such as a webpage forum and a game scenario.

The foregoing is only embodiments of the present invention. The protection scope of the present invention, however, is not limited to the above description. Any change or substitution, easily occurring to those skilled in the art, should be covered by the protection scope of the present invention.

What is claimed is:

1. A system for managing an avatar on an instant messaging (IM) platform, comprising at least one terminal configured to display an avatar; wherein the terminal comprises:
a management module, configured to detect an area where an action takes place, determine a virtual element of a first avatar which is an object of the action according to the area, perform an operation corresponding to the action on the virtual element, update a second avatar by combining the second avatar with the virtual element.

2. The system of claim 1, wherein the management module comprises:
a display module, configured to display virtual elements forming the first avatar and virtual elements forming the second avatar;
a copy module, connected with the display module, configured to copy a first virtual element which is clicked on of the first avatar to obtain a virtual element copy;
a combining module, connected with the display module and the copy module respectively, configured to detect an area which is clicked on or an area where a mouse key is released, determine a second virtual element of the second avatar which is the object of the action according to the area, and replace the second virtual element located in the area with the virtual element copy;
a storage module, connected with the display module, the copy module and the combining module respectively, configured to store the virtual elements forming the second avatar.

3. The system of claim 1, further comprising a purchase server configured to run an e-store; wherein the terminal further comprises:
a purchase module, connected with the management module, configured to obtain a serial number of the first virtual element to be purchased by a user and security information of the user, and transmit the serial number and the security information to the purchase server;
wherein the purchase server is further configured to make a purchase according to the serial number and the security information which are received, and return a result of the purchase.

4. The system of claim 3, wherein the purchase module comprises:
a serial number obtaining module, configured to obtain the serial number of the virtual element to be purchased;
a security check module, connected with the serial number obtaining module, configured to obtain the security information of the user according to a security check policy selected by the purchase server; and
a protocol encapsulation module, connected with the serial number obtaining module and the security check module respectively, configured to perform protocol encapsulation on the serial number and the security information, and transmit a protocol packet obtained by the protocol encapsulation to the purchase server.

5. The system of claim 1, wherein the terminal further comprises:
a save module, connected with the management module and the purchase module respectively, configured to transmit a saving protocol to the purchase server requesting to save the second avatar;
wherein the purchase server is further configured to store the second avatar which is requested to be saved by the save module.

6. The system of claim 1, wherein the terminal further comprises:
a link address query module, configured to obtain a serial number of a virtual element, query an e-store for a link address of the virtual element according to the serial number of the virtual element; and
a webpage jump module, connected with the link address query module, configured to obtain the security information of the user and jump to a position of the virtual element in the e-store according to the link address.

7. A method for managing an avatar on an instant messaging (IM) platform having at least one terminal, comprising:
A) detecting an area where an action takes place and determining a virtual element of a first avatar which is an object of the action according to the area;
B) performing an operation corresponding to the action on the virtual element, updating a second avatar by combining the second avatar with the virtual element.

8. The method of claim 7, wherein the step A comprises:
A1) detecting a first area which is clicked on and determining a first virtual element of the first avatar which is the object of the click according to the first area;
A2) copying the virtual element determined to obtain a virtual element copy;
A3) detecting a second area where a mouse key is released and determining a second virtual element of the second avatar which is the object of the release according to the second area;
A4) replacing the second virtual element in the second area with the virtual element copy.

9. The method of claim 7, further comprising:
after the step B,
C) obtaining, by the terminal, a serial number of a virtual element of the first virtual element to be purchased by a user and security information of the user, and transmitting the serial number and the security information to a purchase server;
D) making, by the purchase server, a purchase according to the serial number and the security information, and returning a result of the purchase.

10. The method of claim 9, wherein the step C comprises:
C1) obtaining the serial number of the virtual element to be purchased and obtaining the security information of the user according to a security check policy selected by the purchase server;
C2) performing protocol encapsulation on the serial number and the security information to obtain a protocol packet, and transmitting the protocol packet to the purchase server.

11. The method of claim 7, further comprising:
transmitting, after the step D by the terminal, a saving protocol to a purchase server requesting to save the second avatar; storing, by the purchase server, the second avatar which is requested to be saved by the terminal.

12. The method of claim 7, further comprising:
obtaining, after the step A4 by the terminal, a serial number of the first virtual element, querying an e-store for a link address of the first virtual element according to the serial number, and jumping to a position of the first virtual element in the e-store according to the link address.
